(19) United States
(12) Patent Application Publication
(10) Pub. No.: US 2016/0079623 A1
(43) Pub. Date: Mar. 17, 2016

(54) METHOD FOR PREPARING SOLID ELECTROLYTE FOR SOLID OXIDE FUEL CELL, AND METHOD FOR PREPARING UNIT CELL

(71) Applicant: KOREA INSTITUTE OF INDUSTRIAL TECHNOLOGY, Chungcheongnam-do (KR)

(72) Inventors: Ho Sung Kim, Gwangju (KR); Seong Jae Boo, Gyeonggi-do (KR); Chae Hwan Jeong, Gwangju (KR); Ik Hyun Oh, Gwangju (KR); Hyeon Jong Jeon, Gwangju (KR); Min Young Kim, Gwangju (KR)

(21) Appl. No.: 14/787,446

(22) PCT Filed: Aug. 20, 2013
(86) PCT No.: PCT/KR2013/007460

§ 371 Date: Oct. 27, 2015

(30) Foreign Application Priority Data
May 3, 2013 (KR) 10-2013-0049816

(51) Int. Cl. H01M 8/12

(52) U.S. Cl. CPC H01M 8/1246; H01M 2300/0071; H01M 2008/1293

(57) ABSTRACT

Provided are a method for preparing a solid electrolyte material for a cheap solid oxide fuel cell capable of implementing high ion conductivity at a medium-low temperature of 800° C. or lower, and a method for preparing a unit cell of a solid oxide fuel cell by using the same. The method for preparing a solid electrolyte material for a solid oxide fuel cell comprises: providing a starting material comprising ytterbium nitrate [Yb(NO₃)₃.H₂O], scandium nitrate [Sc(NO₃)₃.H₂O] and zirconium oxychloride [ZrOCl₂.H₂O] in a ratio of 6:4:90 by mol; forming a mixture metal salt aqueous solution by dissolving the starting material; forming a precursor by mixing the mixture metal salt aqueous solution and a chelating agent and coprecipitating the obtained mixture; washing the precursor by providing ultrapure water multiple times; filtering the washed precursor by using a vacuum filtration apparatus; and forming a solid electrolyte powder by heat treating the filtered precursor.

### TECHNICAL FIELD

Embodiments of the present invention relate to a solid oxide fuel cell (SOFC), and more particularly, to a method of preparing a solid electrolyte for a cheap SOFC capable of implementing high ion conductivity at a medium-low temperature of 800° C. or lower and a method of preparing a unit cell of an SOFC using the same.

### BACKGROUND ART

A fuel cell is defined as a cell capable of producing a direct current by converting chemical energy from a fuel into electricity. As an energy conversion device that produces direct current electricity by electrochemically reacting an oxidizing agent, for example, oxygen, and a gaseous fuel, for example, hydrogen, through an oxide electrolyte, the fuel cell continuously produces electricity by supplying fuel and air from an external source, which differs from an existing cell. Types of the fuel cell include a molten carbonate fuel cell (MCFC) and a solid oxide fuel cell (SOFC) that operate at high temperatures, and a phosphoric acid fuel cell (PAFC), an alkaline fuel cell (AFC), a proton exchange membrane fuel cell (PEMFC), and a direct methanol fuel cell (DEMFC) that operate at relatively low temperatures.

The SOFC, a system that operates at a high temperature of about 600 to 900° C., has high efficiency, excellent performance, and excellent cost efficiency due to diversity of fuel selection. The SOFC uses solid materials and thus, is simply structured and free from issues of loss and replenishment of electrode materials, and corrosion, compared to general cells. The SOFC does not require expensive noble metal catalysts, and immediately uses hydrocarbon without a reformer. The SOFC has potential to be a high performance, clean, and high efficient power source in that the SOFC increases thermal efficiency up to 80% using waste heat generated when discharging high temperature gas, and also has an advantage of enabling cogeneration.

In general, a unit cell of the SOFC is classified into a cylindrical type and a flat plate type by shapes, and also classified into an anode supporter type, a cathode supporter type, and an electrolyte supporter type by structures. However, recently, research and development of an anode supporter type unit cell have been actively conducted to adjust an operating temperature of the SOFC to be a medium-low temperature, improve durability, and reduce costs.

The anode supporter type unit cell includes an anode reaction layer, for example, a function layer, a solid electrolyte layer, and a cathode reaction layer. The existing anode supporter type unit cell requires a sintering process for each operation of forming an anode supporter, an anode reaction layer, an electrolyte layer, or a cathode layer. Thus, a great amount of time and costs are used and a quality reliability decreases due to a high defect rate.

In detail, according to the related art, a unit cell of an SOFC is prepared using an extrusion or pressure method. Such a preparing process has difficulties in controlling a formability of a supporter, and accompanies a multi-stage deep coating and sintering process to achieve a desired thickness. Thus, it is difficult to maintain quality reproducibility and reliability. Further, according to the related art, cracks may occur in a portion with weak formability, and a poor uniformity of a thin film may cause a number of quality issues, such as a contact failure between interfaces of a unit cell, for example. Further, the unit cell of the SOFC prepared by the related art has difficulties in controlling the formability deterioration, and a dimension and a microstructure of each layer due to an increase in an area of the unit cell. In addition, the output performance and the durability of the unit cell are degraded.

Basically, the unit cell of the SOFC includes anode (NiO/YSZ), solid electrolyte (YSZ), and cathode (LSM/YSZ) materials. A hydrogen fuel is oxidized at the anode, whereby protons and electrons are generated. The electrons are supplied to the cathode through an external circuit. Oxygen is reduced at the cathode, whereby oxygen anions are generated. The oxygen anions are moved to the anode through a solid electrolyte by an oxygen partial pressure difference, and react with hydrogen ions, whereby water is generated.

When an operating temperature of the existing SOFC is above 900° C., the durability of a ceramic material reduces. Thus, research for lowering the operating temperature to a medium-low temperature of 700 to 800° C. has been conducted. In general, when the operating temperature of the SOFC is lowered, an ion conductivity of the solid electrolyte greatly decreases. Thus, a high ion conductive solid electrolyte material to replace the existing YSZ-based solid electrolyte material with is under consideration.

Meanwhile, to develop a cell, in detail, to develop an SOFC that performs a high output at a medium-low temperature, an 11ScSZ or 1Ce10ScSZ solid electrolyte material is considered. However, a raw material of ScSZ material-based scandium is considerably expensive and thus, difficult to be commercialized. Accordingly, to reduce costs for commercialization while maintaining the high output of the SOFC under the medium-low temperature operating condition, an amount of scandium to be used for the solid electrolyte is to be reduced. As a method of preparing a scandium-based solid electrolyte, hydrothermal synthesis is attempted. However, the hydrothermal synthesis prepares a solid electrolyte at relatively high costs and thus, effects of reducing overall costs for preparing a unit cell of the SOFC are insignificant. In detail, a powder prepared by the hydrothermal synthesis has a nanostructure with a relatively large specific surface area. Accordingly, it is difficult to prepare a solid electrolyte film constituting a unit cell of an SOFC at low costs. When solid electrolyte films are combined and used as ion conductive solid electrolytes of an anode and a cathode, technology for dispersing a slurry prepared by a wet process such as tape casting is difficult, and preparing a tape casting film of uniform oxide dispersion is also difficult.

### DISCLOSURE OF INVENTION

### Technical Goals

An aspect of the present invention provides a method of preparing a cheap scandium-based solid electrolyte that may implement a high ion conductivity at a medium-low operating temperature of 800° C. or lower to commercialize a solid oxide fuel cell (SOFC) and a method of preparing a unit cell of an SOFC using the same.

### Technical Solutions

According to an aspect of the present invention, there is provided a method of preparing a solid electrolyte for a solid oxide fuel cell (SOFC), the method including providing a starting material including ytterbium nitrate [Yb(NO₃)₃.H₂O], scandium nitrate [Sc(NO₃)₃.H₂O], and zirconium oxychloride [ZrOCl₂.H₂O] at a ratio of 6:4:90 by mol, forming a mixture metal salt aqueous solution by dissolving the starting material, forming a precursor by mixing the mixture metal salt aqueous solution and a chelating agent and coprecipitating the obtained mixture, washing the precursor with ultrapure water multiple times, filtering the washed precursor using a vacuum filtration apparatus, and forming a solid electrolyte powder by heat treating the filtered precursor.

A concentration of ytterbia (Yb) in the ytterbium nitrate may be 1 to 8 moles. Preferably, the concentration of the ytterbia may be 6 moles.

The mixture metal salt aqueous solution may be formed at a concentration of 0.25 moles. 5-normality ammonia water may be used as the chelating agent, and the chelating agent may be mixed to form the mixture metal salt aqueous solution having a pH level of 10. Here, the mixing may include titrating the mixture metal salt aqueous solution at a speed of 4 milliliters per minute (ml/min), and titrating the chelating agent at a speed of 7.5 ml/min to maintain a pH level of 9. Further, the filtering may include removing ammonia ion and chlorine ion impurities (NH₄+, Cl−) from the washed precipitate. Here, the method may further include, after the filtering, verifying whether a chlorine ion remains in the filtered precipitate, and the verifying may be performed using a silver nitrate (AgNO₃) aqueous solution having a concentration of 0.1 moles.

The heat treating may be performed in a temperature range of 600 to 1,500° C. Preferably, the heat treating may be performed in a temperature range of 800 to 900° C.

According to another aspect of the present invention, there is also provided a method of preparing a unit cell of an SOFC, the method including preparing a YbScSZ solid electrolyte material using coprecipitation, forming an electrolyte slurry by mixing a solvent, a dispersant, and a binder with the YbScSZ solid electrolyte material, forming an electrolyte film by applying the electrolyte slurry using tape casting, forming an anode slurry by mixing NiO and YSZ at a ratio of 60:40, forming an anode sheet by applying the anode slurry using tape casting, stacking multiple sheets of the anode sheet and stacking multiple sheets of the electrolyte films on the stacked anode sheets, forming an anode supporter type electrolyte assembly by performing lamination, calcination, and cofiring in the state of being stacked, applying a cathode formed by mixing LSM and YSZ at a ratio of 60:40 to an electrolyte of the assembly using screen printing, and calcining and cofiring the cathode-applied assembly. Here, the preparing may include providing a starting material comprising ytterbium nitrate [Yb(NO₃)₃.H₂O], scandium nitrate

[Sc(NO₃)₃.H₂O], and zirconium oxychloride [ZrOCl₂.H₂O] at a ratio of 6:4:90 by mol, forming a mixture metal salt aqueous solution by dissolving the starting material, forming a precursor by mixing the mixture metal salt aqueous solution and a chelating agent and coprecipitating the obtained mixture, washing the precursor with ultrapure water multiple times, filtering the washed precursor using a vacuum filtration apparatus, and forming a solid electrolyte powder by heat treating the filtered precursor.

The electrolyte film may be formed in a thickness of 5 to 10 micrometers (μm). Preferably, the electrolyte film may be formed in a thickness of 8 μm.

### Advantageous Effect

As described above, according to embodiments of the present invention, an ScSZ-based oxygen ion conductive solid electrolyte material (YbScSZ) may be produced using coprecipitation at low costs, a unit cell of a solid oxide fuel cell (SOFC) may be prepared by tape casting and co-sintering using the oxygen ion conductive solid electrolyte material, and a high-output performance may be implemented.

### BRIEF DESCRIPTION OF DRAWINGS

FIG. 1 is a flowchart illustrating a method of preparing a solid electrolyte for a solid oxide fuel cell (SOFC) according to an embodiment of the present invention.

FIG. 2 is a table illustrating the composition of a slurry for preparing a solid electrolyte for an SOFC using a solid electrolyte material prepared by the preparing method of FIG. 1.

FIGS. 3A and 3B are graphs illustrating thermogravimetry analysis (TGA)/differential scanning calorimetry (DSC) thermal behavior analysis results of the solid electrolyte material prepared by the preparing method of FIG. 1.

FIG. 4 is a graph illustrating XRD analysis results with respect to a heat treating temperature of the solid electrolyte material prepared by the preparing method of FIG. 1.

FIGS. 5A and 5B are graphs illustrating changes in a size of a host crystal with respect to a heat treating temperature of the solid electrolyte material prepared by the preparing method of FIG. 1.

FIG. 6 is a graph illustrating results of evaluating an ion conductivity of the solid electrolyte material prepared by the preparing method of FIG. 1.

FIGS. 7 and 8 are graphs illustrating results of evaluating an output performance and a polarization characteristic using a unit cell of an SOFC prepared using the solid electrolyte material prepared by the preparing method of FIG. 1.

### BEST MODE FOR CARRYING OUT THE INVENTION

Hereinafter, reference will now be made in detail to embodiments of the present invention with reference to the accompanying drawings. However, the present invention is not limited to the embodiments. When describing the embodiments, detailed descriptions of a know function or configuration may be omitted to clarify the substance of the present invention.

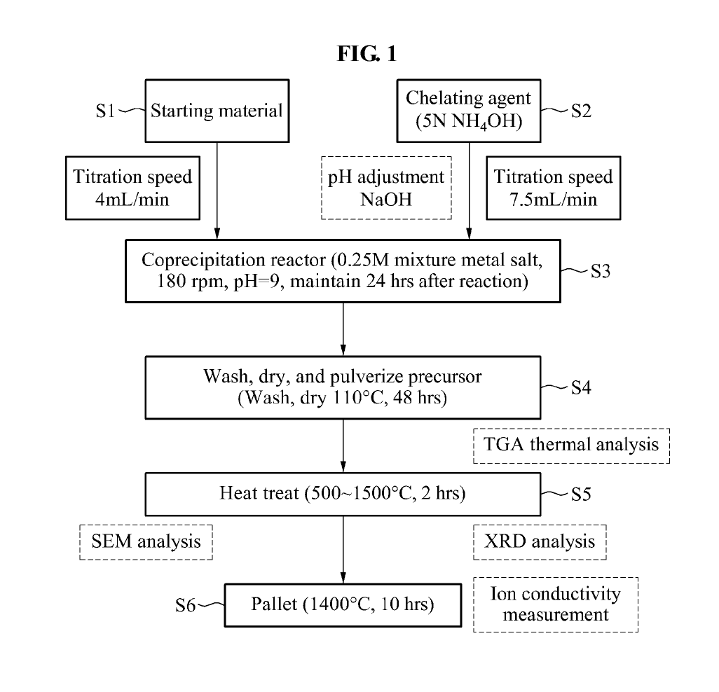

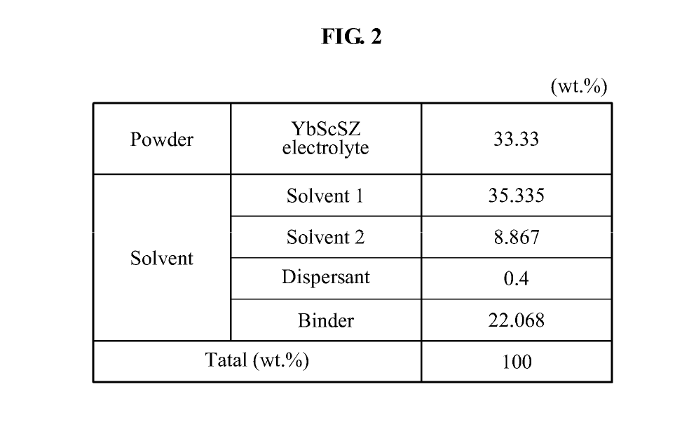

Hereinafter, a method of preparing a solid electrolyte for a solid oxide fuel cell (SOFC) according to an embodiment of the present invention will be described in detail with reference to FIGS. 1 through 10. For reference, FIG. 1 is a flowchart illustrating a method of preparing a solid electrolyte for an SOFC according to an embodiment of the present invention. FIG. 2 is a table illustrating the composition of a slurry for preparing a solid electrolyte for an SOFC using a solid electrolyte material prepared by the preparing method of FIG. 1.

Referring to the drawings, with respect to the solid electrolyte for the SOFC, to develop a cheap solid electrolyte with an excellent ion conductivity at a medium-low temperature, a solid electrolyte material more excellent in an ion conductivity than a YSZ-based solid electrolyte material and cheaper than an ScSZ-based solid electrolyte material may be developed. Further, the cost may be reduced by employing the ScSZ-based solid electrolyte in which a portion of scandium is replaced with a Yb component.

A method of preparing [(Yb₂O₃)_{0.06}(Sc₂O₃)_{0.04}(ZrO₂)_{0.0}] corresponding to a solid electrolyte material for an SOFC will be described.

Referring to FIG. 1, the preparing method prepares a starting material in operation S1, and forms a mixture metal salt aqueous solution by mixing the starting material with ultrapure water.

The starting material may include ytterbium nitrate [Yb(NO₃)₃.H₂O], scandium nitrate

[Sc(NO₃)₃.H₂O], and zirconium oxychloride [ZrOCl₂.H₂O]. The starting material is used to prepare the mixture metal salt aqueous solution by weighing initial source materials so that a ratio of Yb₂O₃:Sc₂O₃:ZrO₂ by mol corresponds to 6:4:90, and dissolving the initial source materials in ultrapure water so that the total concentration of metal salt corresponds to 0.25 mol (M) concentration. Here, ytterbia (Yb) having a concentration of 1 to 8 moles may be used for the ytterbium nitrate, and preferably, the concentration of ytterbia may be 6 moles.

The preparing method mixes the mixture metal salt aqueous solution with a chelating agent in operation S2, and prepares a precursor by coprecipitating the obtained mixture in operation S3.

Here, ammonia water (NH₄OH) may be used as the chelating agent. For example, the method prepares the chelating agent by mixing 5-normality ammonia water with ultrapure water as a base solution and preparing an aqueous solution having a pH level of 10 in a 10-liter (L) batch.

The preparing method titrates the mixture metal salt aqueous solution at a speed of 4 milliliters per minute (ml/min) while stirring the base solution of the chelating agent prepared as described above. At the same time, the preparing method titrates the 5-normality ammonia water at a speed of 7.5 ml/min to maintain a pH level of 9. After titrating the mixture metal salt aqueous solution and the chelating agent, the preparing method maintains stirring for ripening for 24 hours. After suspending the stirring, the preparing method forms a precursor by precipitating a metal hydroxide for 3 hours.

The preparing method washes, dries, and pulverizes the precursor in operation S4.

In detail, when the precursor is precipitated, the preparing method drains an aqueous solution at an upper portion of the precipitated precursor, pours ultrapure water over the precipitate, and stirs. After stirring, the precursor is washed repeatedly multiple times by precipitating the precursor, draining an aqueous solution at an upper portion, pouring ultrapure water again, and stirring. For example, the washing may be repeated at least five times.

The preparing method filters the washed precursor precipitate using a vacuum filtration apparatus, and washes the filtered precursor precipitate with ultrapure water to remove ammonia ion and chlorine ion impurities (NH₄+, Cl−) from the precursor precipitate. Here, whether a chlorine ion remains in the filtered precursor may be verified by reacting a silver nitrate (AgNO₃) aqueous solution having a concentration of 0.1 moles with the filtered solution.

The preparing method dries the washed precursor precipitate at 110° C. for 48 hours, and pulverizes the dried precursor. Here, the dried precursor may be primarily pulverized using a zirconia grinding ball with a diameter of 10 millimeters (mm).

The preparing method prepares a powder of a solid electrolyte material by heat treating the washed, dried, and pulverized powder in operation S5.

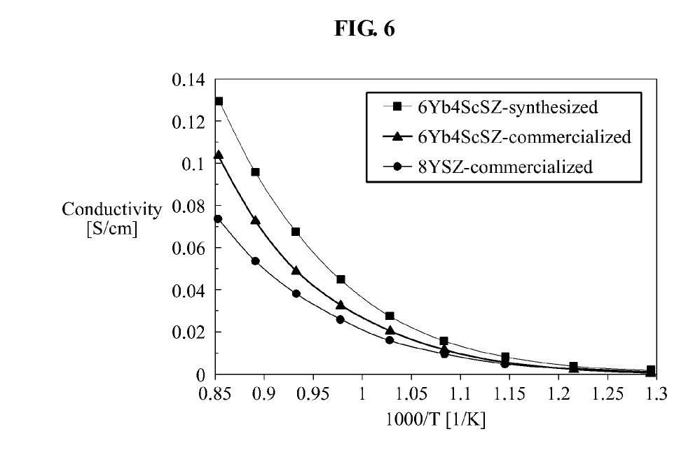

Here, for crystallization growth, the preparing method calcines a particle of the heat treated powder at 500 to 1,500° C. for 2 hours. In this example, a heating rate of the heat treating is set to 5° C./min. By pulverizing the calcined powder using the zirconia grinding ball with the diameter of 10 mm, 6Yb4ScSZ is prepared as the solid electrolyte material for the SOFC. The preparing method measured an ion conductivity of the solid electrolyte using the 6Yb4ScSZ powder prepared as described above in operation S6. To measure the ion conductivity, the preparing method prepares a specimen by performing a uniaxial pressing method on the prepared powder. For example, the preparing method prepares a measurement specimen by putting the powder prepared by the aforementioned method in a circular mold, pressing the powder at a pressure of 60 MPa for 20 minutes, sintering the pressed powder at 1,400° C. for 10 hours, and processing the sintered powder in a form of a rectangular parallelepiped. Using an AC2-prove method on the prepared specimen, the preparing method measures the ion conductivity by performing measurement in heating and cooling atmosphere within a temperature range of 500 to 900° C. and calculating an average thereof. The ion conductivity measured as described above is illustrated in FIG. 6.

The preparing method forms a slurry to prepare a solid electrolyte using the solid electrolyte material prepared as described above. A thin solid electrolyte film is prepared using a YbScSZ material by a tape casting process. FIG. 2 illustrates the composition of the slurry for preparing the thin solid electrolyte film using the YbScSZ material. Referring to FIG. 2, a solid electrolyte slurry is formed by mixing a first solvent of 35.335 wt %, a second solvent of 8.867 wt %, a dispersant of 0.4 wt %, and a binder of 22.068 wt % with the prepared YbScSZ powder of 33.33 wt %.

Here, the solid electrolyte is to be formed as a thin film to minimize an ohmic resistance, and tape casting is used herein. To prepare a solid electrolyte film, a high viscosity of about 800 centipoises (cP) or higher is required. According to the present embodiment, to form a high-viscosity slurry, the preparing method mixes the solvents, the dispersant, and the prepared powder, puts the mixture in a 500 ml Nalgene bottle, fills the bottle with 250 g of zirconia balls having a diameter of 1 mm, performs ball milling for 24 hours at a speed of 200 rpm, adds the binder, and performs ball milling another 24 hours, and thereby prepares the electrolyte slurry.

The prepared slurry is prepared in a form of a film with a predetermined thickness on a PET film using a tape casting apparatus. Here, the tape casting process for preparing the electrolyte film may form an electrolyte film with a thickness of about 8 micrometers (μm) under a dry condition in which a height of a doctor blade is 75 μm and a temperature is 80° C.

For reference, a tape casting apparatus 100 according to the present embodiment includes a storage unit 110, a transfer unit 120, a blade 130, a height adjustment unit 140, and a heating unit 150. However, the tape casting apparatus 100 does not correspond to the gist of the present invention and thus, the tape casting apparatus 100 will be described in brief and detailed configurations and descriptions thereof will be omitted.

The storage unit 110 stores the electrolyte slurry S prepared as described above. A lower portion of the storage unit 110 is opened to discharge the electrolyte slurry S to an outside. The transfer unit 120 transfers a transfer film T in one direction, and the electrolyte slurry S is applied to the transfer unit 120. For example, the transfer unit 120 includes transfer motors configured to rotate in one direction, and winding rolls connected to the transfer motors to rotate together. The transfer film T to which the electrolyte slurry S is applied is wound over the winding rolls. Further, meanwhile, the transfer film T includes a PET material. The blade 130 is provided on a path along which the electrolyte slurry S is discharged. The blade 130 adjusts a discharge quantity of the electrolyte slurry S and thereby controls the thickness of the electrolyte slurry S to be applied to the transfer film T. Herein, the blade 130 including a first blade 132 and a second blade 134 disposed on the discharge path of the electrolyte slurry S is illustrated. However, the present invention is not limited thereto. The configuration and shape of the blade 130 may be modified or changed variously. The height adjustment unit 140 adjusts a vertical height of the blade 130 to change the thickness of the electrolyte slurry S to be applied to the transfer film T. The heating unit 150 is provided on a path along which the transfer film

T is transferred. The hearing unit 150 supplies heat to the transfer film T.

According to the present invention, the tape casting apparatus 100 is used to prepare a solid electrolyte for an SOFC of a thin film at low costs.

A method of preparing a solid electrolyte film according to an embodiment of the present invention will be described in brief. First, an electrolyte slurry S is put, and a height of the blade 130 is suitably adjusted by the height adjustment unit 140 based on a thickness of a film to be prepared. For example, the solid electrolyte film is formed in a thickness of 5 to 10 μm, and preferably, 8 μm. For this, the height of the blade 130 is adjusted to be 75 μm.

When rotating the transfer motors to maintain a constant moving speed of the transfer film T, the transfer film T is moved on or above the heating unit 150 in a direction of an arrow, and the electrolyte slurry S of a predetermined thickness is coated on the transfer film T. Here, the tape casting apparatus 100 prepares a film P by providing the electrolyte slurry S at a predetermined speed when preparing the film P.

While maintaining the temperature of the transfer film T to be a suitable temperature using the heating unit 150, a bipolar plate is dried and prepared. For example, a dry temperature of the film P in the tape casting apparatus 100 is 80° C. Here, heat treating or drying is performed at a time by maintaining the temperature to be about 80° C., whereby contraction, detachment, or cracks may be prevented.

According to the present embodiment, the tape casting process may achieve a satisfactory thickness adjustment and a desired surface condition through a low-cost process for producing high-quality laminating components. Further, using the tape casting process, a satisfactory thickness adjustment and a desired surface condition may be achieved at low costs. In addition, a low-cost solid electrolyte may be prepared by the tape casting process using an electrolyte slurry dissolved in a solvent, and a thin solid electrolyte film of about 8 μm may be prepared.

The performance of a unit cell is evaluated by applying the solid electrolyte prepared as described above to an SOFC. To evaluate the performance of the SOFC, a coin type unit cell was prepared. In detail, an anode reaction layer (NiO/YSZ) of about 10 to 50 μm is stacked on an anode (NiO/YSZ) supporter having a thickness of about 1 to 1.5 mm. By additionally stacking the solid electrolyte thin film prepared as described above on the anode reaction layer, an anode-supported electrolyte assembly is formed and sintered. Finally, a cathode (LSM/YSZ) is prepared on an electrolyte pellet of the assembly by screen printing. Here, the electrolyte is formed in a thickness of about 5 to 20 μm by stacking a single sheet of the solid electrolyte thin film or multiple sheets of the solid electrolyte thin film.

In detail, a slurry is formed by maintaining a ratio of NiO and YSZ to be 60:40 to form the anode supporter, and an anode sheet with a thickness of 40 μm is prepared using tape casting. By stacking 40 to 60 sheets of the prepared anode sheet, an anode supporter with a thickness of about 0.8 to 1.5 mm is formed. The slurry is prepared using the same method as the method of forming the anode supporter. A YbScSZ electrolyte thin film (applying a YbSCSZ powder with a surface area of 20 m²/g or less) of about 5 to 10 μm is prepared by tape casting, and stacked on the anode supporter. An anode supporter type electrolyte pellet is formed by performing lamination with a force of 400 kgf/cm² at a temperature of 80° C. for about 20 minutes in a state in which the electrolyte is stacked, and performing calcination and cofiring. Here, the temperature is increased up to 1,000° C. to remove carbon corresponding to a porous agent while composing the anode supporter, and maintained for about 3 hours. Calcination is processed while maintaining a room temperature, and heat treating, for example, cofiring, is performed at about 1,400° C. for 3 hours, whereby the anode supporter type electrolyte assembly (sintering state) is prepared.

A cathode slurry in which a ratio of LSM and YSZ corresponds to 60:40 is applied to a solid electrolyte of the assembly in a thickness of about 30 to 60 μm by a screen printer, and sintering is performed, for example, at about 1,100° C., whereby a unit cell is prepared.

According to embodiments of the present invention, an ScSZ-based oxygen ion conductive solid electrolyte material (YbScSZ) may be produced at lower costs using coprecipitation. Further, an SOFC having a high output performance may be implemented using a solid electrolyte material prepared by tape casting and co-sintering.

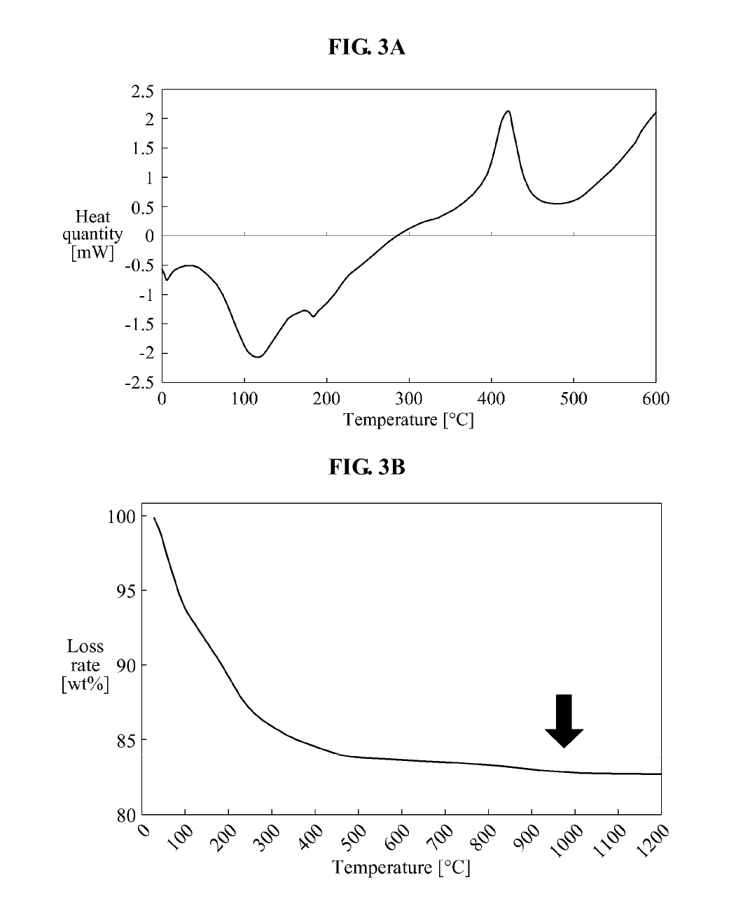

Hereinafter, performances of a unit cell and a solid electrolyte material for the SOFC prepared as described above will be evaluated. Results of the evaluation are illustrated in FIGS. 3A through 10.

For reference, FIGS. 3A and 3B are graphs illustrating thermogravimetry analysis (TGA)/differential scanning calorimetry (DSC) thermal behavior analysis results of the solid electrolyte material prepared by the preparing method of FIG. 1. Here, FIGS. 3A and 3B illustrate results of performing a TGA/DSC thermal behavior analysis with respect to a precursor (6Yb4ScSZ) powder being wet immediately after prepared using coprecipitation. Referring to the drawings, as shown in FIG. 3A, a solid electrolyte material has a crystallization peak behavior at about 400° C. as the result of the DSC analysis. As shown in FIG. 3B, crystallization is performed with an increase in a sintering temperature when calcination is completed at about 500° C. as the result of the TGA, and a change in weight does not occur anymore around 950° C.

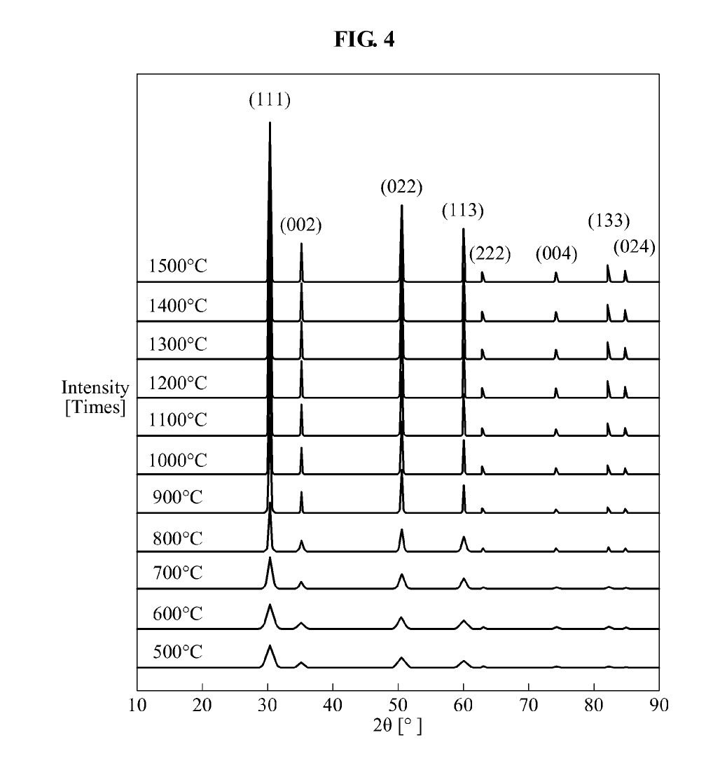

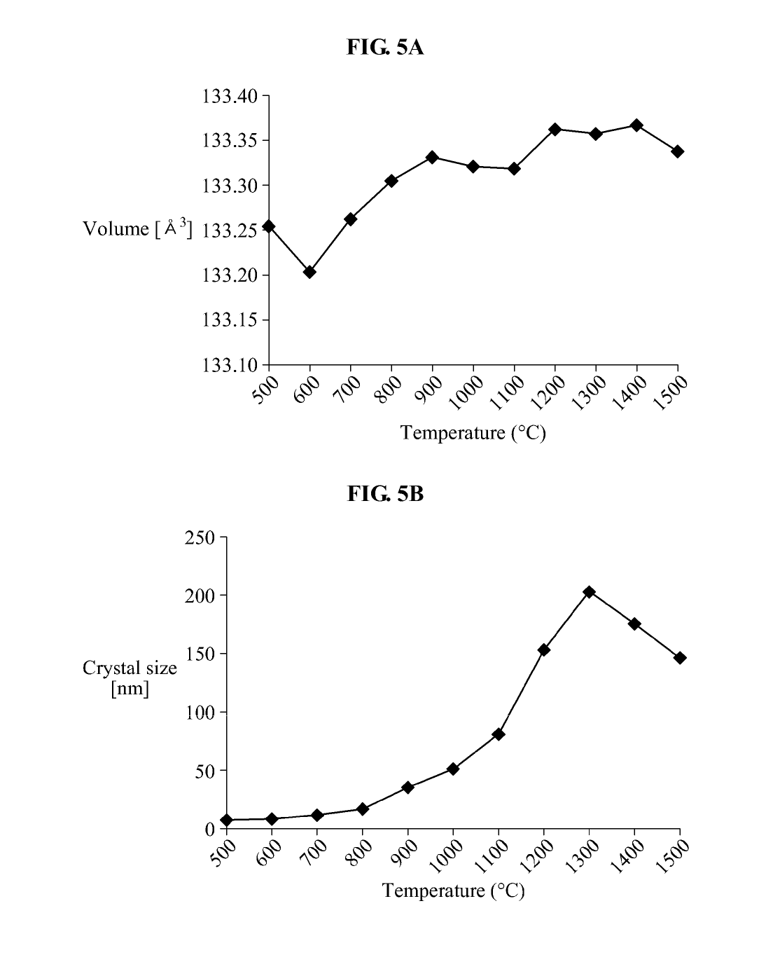

FIG. 4 is a graph illustrating XRD analysis results with respect to a heat treating temperature of the solid electrolyte material prepared by the preparing method of FIG. 1, and FIGS. 5A and 5B are graphs illustrating changes in a size of a host crystal with respect to a heat treating temperature of the solid electrolyte material prepared by the preparing method of FIG. 1. Here, the heat treating was performed with respect to the precursor prepared as described above in a range of 500 to 1,500° C.

Referring to the drawings, a cubic crystal structure and a space group of Fm-3m after heat treating is performed are illustrated. The crystal structure does not change with respect to the entire heat treating period, and a characteristic of a stable crystal structure in which impurity peaks are absent is represented. According to the foregoing, a powder corresponding to an 800 to 900° C. period is suitable as a result of reviewing in view of a crystallite size of a primary particle, a powder state of a secondary particle, a change with respect to an increase in temperature of a crystal constant, and a volume change that are suitable for preparing a thin solid electrolyte film by tape casting using the 6Yb4ScSZ solid electrolyte material prepared by embodiments of the present invention.

FIG. 6 is a graph illustrating results of evaluating an ion conductivity of the solid electrolyte material prepared by the preparing method of FIG. 1. Referring to the drawing, the YbScSZ solid electrolyte material prepared by embodiments of the present invention has a more excellent ion conductivity than an existing YSZ material and a commercial YbScSZ material. In detail, the ion conductivity of the solid electrolyte prepared according to embodiments of the present invention at 800° C. is about 0.68 S/cm, which is higher than the ion conductivity 0.036 S/cm of the existing YSZ material and the ion conductivity 0.049 S/cm of the commercial YbScSZ material.

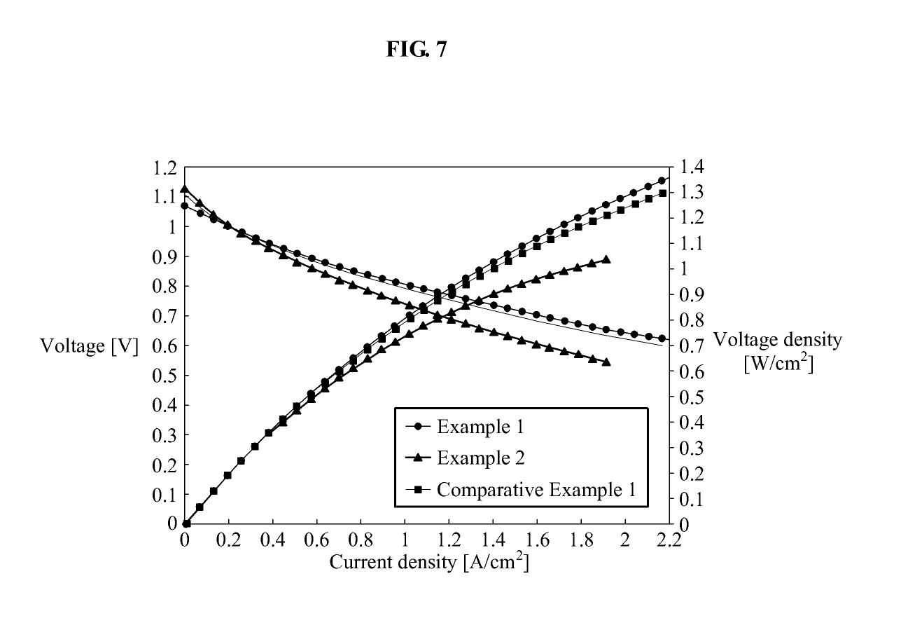

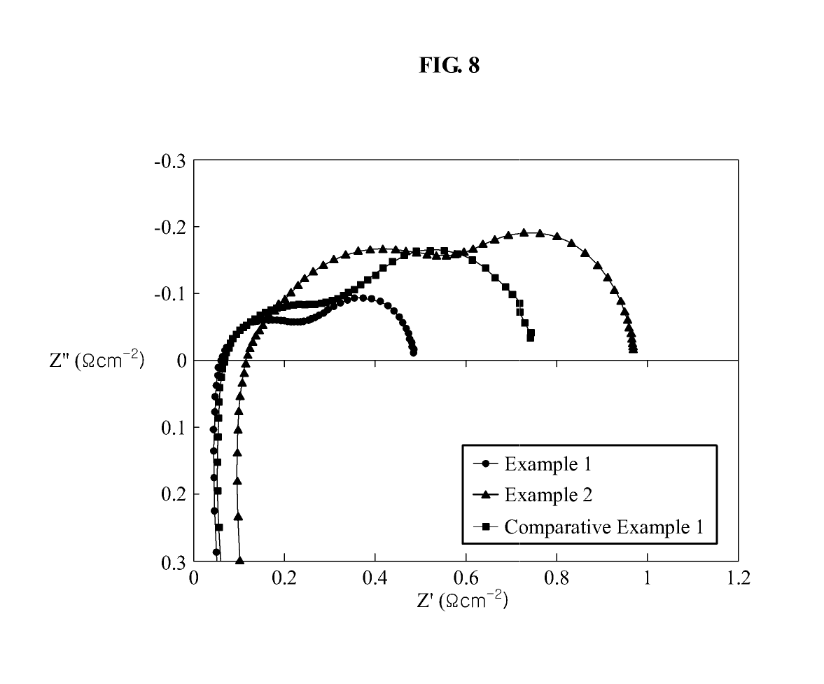

FIGS. 7 and 8 are graphs illustrating results of evaluating an output performance and a polarization characteristic using a unit cell of an SOFC prepared using the solid electrolyte material prepared by the preparing method of FIG. 1. For reference, in Example 1, a solid electrolyte material was prepared by heat treating at 850° C. a precursor (6Yb4ScSZ) prepared using coprecipitation as described above, and a unit cell of a solid electrolyte fuel cell was prepared as described above. In Example 2, similar to Example 1, a solid electrolyte material was prepared using a precursor (6Yb4ScSZ) prepared using coprecipitation, and a unit cell of a solid electrolyte fuel cell was prepared as described above. However, in Example 2, the solid electrolyte material was heat treated at 900° C. In Comparative Example 1, a unit cell of a solid electrolyte fuel cell was prepared by the same method as those of Examples 1 and 2 using a commercial trial product (YbScSZ) powder prepared by an existing method.

Referring to the drawings, the output characteristics of the unit cells prepared in Examples 1 and 2 correspond to 1.3 W/cm² (2.2 A/cm², 800° C.), and the polarization characteristics thereof shows a relatively low value of about 0.06 Ωcm² (800° C.). The output characteristics and the polarization characteristics of Examples 1 and 2 exhibit relatively excellent results, compared to the output characteristic of 1.0 W/cm² (1.8 A/cm², 800° C.) and the polarization characteristic of about 0.12 Ωcm² of Comparative Example 1. According to embodiments of the present invention, an ion conductivity and an output performance of a 6Yb4ScSZ solid electrolyte material prepared using coprecipitation exhibit performance improvement of about 23% or higher, compared to those of an existing solid electrolyte material and a commercial YbScSZ material.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A method of preparing a solid electrolyte for a solid oxide fuel cell (SOFC), the method comprising:
providing a starting material comprising ytterbium nitrate [Yb(NO₃)₃.H₂O], scandium nitrate [Sc(NO₃)₃.H₂O], and zirconium oxychloride [ZrOCl₂.H₂O] at a ratio of 6:4:90 by mol;
forming a mixture metal salt aqueous solution by dissolving the starting material;
forming a precursor by mixing the mixture metal salt aqueous solution and a chelating agent and coprecipitating the obtained mixture;
washing the precursor with ultrapure water multiple times;
filtering the washed precursor using a vacuum filtration apparatus; and
forming a solid electrolyte powder by heat treating the filtered precursor.

2. The method of claim 1, wherein a concentration of ytterbia (Yb) in the ytterbium nitrate is 1 to 8 moles.

3. The method of claim 2, wherein the concentration of the ytterbia is 6 moles.

4. The method of claim 1, wherein the mixture metal salt aqueous solution is formed at a concentration of 0.25 moles.

5. The method of claim 1, wherein 5-normality ammonia water is used as the chelating agent, and the chelating agent is mixed to form the mixture metal salt aqueous solution having a pH level of 10.

6. The method of claim 5, wherein the mixing comprises titrating the mixture metal salt aqueous solution at a speed of 4 milliliters per minute (ml/min), and titrating the chelating agent at a speed of 7.5 ml/min to maintain a pH level of 9.

7. The method of claim 1, wherein the filtering comprises removing ammonia ion and chlorine ion impurities (NH₄+, Cl−) from the washed precipitate.

8. The method of claim 7, further comprising:
verifying whether a chlorine ion remains in the filtered precipitate,
wherein the verifying is performed using a silver nitrate (AgNO₃) aqueous solution having a concentration of 0.1 moles.

9. The method of claim 1, wherein the heat treating is performed in a temperature range of 600 to 1,500° C.

10. The method of claim 9, wherein the heat treating is performed in a temperature range of 800 to 900° C.

11. A method of preparing a unit cell of a solid oxide fuel cell (SOFC), the method comprising:
preparing a YbScSZ solid electrolyte material using coprecipitation;
forming an electrolyte slurry by mixing a solvent, a dispersant, and a binder with the YbScSZ solid electrolyte material;
forming an electrolyte film by applying the electrolyte slurry using tape casting;
forming an anode slurry by mixing NiO and YSZ at a ratio of 60:40;
forming an anode sheet by applying the anode slurry using tape casting;
stacking multiple sheets of the anode sheet and stacking multiple sheets of the electrolyte films on the stacked anode sheets;
forming an anode supporter type electrolyte assembly by performing lamination, calcination, and cofiring in the state of being stacked;
applying a cathode formed by mixing LSM and YSZ at a ratio of 60:40 to an electrolyte of the assembly using screen printing; and
calcining and cofiring the cathode-applied assembly,
wherein the preparing comprises:
providing a starting material comprising ytterbium nitrate [Yb(NO₃)₃.H₂O], scandium nitrate [Sc(NO₃)₃.H₂O], and zirconium oxychloride [ZrOCl₂.H₂O] at a ratio of 6:4:90 by mol;
forming a mixture metal salt aqueous solution by dissolving the starting material;
forming a precursor by mixing the mixture metal salt aqueous solution and a chelating agent and coprecipitating the obtained mixture;
washing the precursor with ultrapure water multiple times;
filtering the washed precursor using a vacuum filtration apparatus; and
forming a solid electrolyte powder by heat treating the filtered precursor.

12. The method of claim 11, wherein the electrolyte film is formed in a thickness of 5 to 10 micrometers (μm).

13. The method of claim 12, wherein the electrolyte film is formed in a thickness of 8 μm.
